(19) United States
(12) Patent Application Publication
(10) Pub. No.: US 2011/0273632 A1
(43) Pub. Date: Nov. 10, 2011

(54) VIDEO DISPLAY WITH DETACHABLE INPUT/OUTPUT CONSOLE

(76) Inventor: Michael B. Casey, Smyrna, GA (US)

(21) Appl. No.: 13/099,400

(22) Filed: May 3, 2011

Related U.S. Application Data
(60) Provisional application No. 61/330,946, filed on May 4, 2010.

(51) Int. Cl. H04N 5/64

(52) U.S. Cl. 348/839; 348/E05.128

(57) ABSTRACT

A flat panel video display comprising a separable and removable cartridge comprising connectors and/or circuitry of the input/output electronics that can be removed from the video display. The input/output (and optionally the A/C power) circuitry is enclosed in the cartridge, which can be inserted into and removed from a similarly shaped cavity in the case of the video display. Both the cartridge and cavity have corresponding channels allowing the cartridge to slide properly into place while preventing incorrect insertion of the cartridge. Once fully inserted into the cavity, all electronic connections are made between the circuit board (and optionally A/C power) in the cartridge and the rest of the video display are made allowing the video display to function normally. The cartridge body has a latching mechanism tensioned by a spring allowing it to lock into place. The latch is disengaged by depressing a button on the exposed side of the cartridge, allowing the cartridge to be removed. The lip of the cartridge around the depressed button can serve as a handle to pull out the cartridge. If A/C power is integrated into the cartridge, the latch can activate a switch that breaks the connection of the hot wire and the neutral (leaving the ground connected) cutting power to all electronics in the cartridge and video display and preventing a potentially harmful arc while removing or inserting the cartridge.

### STATEMENT OF RELATED APPLICATIONS

This application claims the benefit of U.S. Provisional Patent Application No. 61/330,946 filed on 4 May 2010, which is incorporated herein in its entirety by this reference.

### BACKGROUND OF THE INVENTION

1. Technical Field

The present invention relates generally to the field of input/output connectors for electronic devices, and relates more specifically to the field of detachable input/output connectors for video displays, particularly wall-mountable video displays.

2. Prior Art

With the advent of new video display technologies (plasma, LCD, LED, laser, etcetera), video displays (for example televisions) have become thin and light enough to be routinely mounted directly to walls. Many mounting methods (especially on larger displays) do not allow the display to be extended away from the wall while mounted. In other words, the displays are mounted relatively flush to the wall and do not have hinged, pivoting, or accordion means to allow them to be extended form the wall while still being mounted on the wall. Because of a lack of space on the sides of the display and to reduce clutter and to increase aesthetics, the majority of the input/outputs of video display is on the back, where they are inaccessible while the unit is mounted, making it highly inconvenient to connect or disconnect external and peripheral devices (power cords, cable or satellite television boxes, DVD and Blu-Ray® players, etcetera) to the display. In such a configuration, one must connect all devices (or at least their cables) to the display before mounting it. To add or remove a device (for example a newly purchased Blu-Ray® player) requires dismounting the display, which may take two people on larger displays and then remounting it.

Although there is sometimes a side input panel on certain displays, such a side input panel usually has very few connections. Additionally, all connected wires are visible to people viewing the display, which is undesirable. In the future, high bandwidth wireless systems likely will allow devices to communicate with displays without the need for cables at all; however, these systems have not yet been finalized and likely will initially be very expensive and slowly adopted.

Therefore, it can be seen that there is a need for an alternative method for connecting external and peripheral devices and power cords to a video display. It is to this need, and other needs, that the present invention is directed.

### BRIEF SUMMARY OF THE INVENTION

Briefly, the present invention is a modular, removable input/output console that allows the user to connect and disconnect power cords and external and peripheral devices to a video display without having to dismount and remount the video display. Even when adoption of wireless technology is widespread, the present device will have the advantage of providing a relatively low cost alternative for lower end video displays. Another advantage of this modularity is the ability for the user to easily replace a defective input/output component, or upgrade to a newer, different, or more comprehensive input/output configuration with more or different components and devices and/or the ability to add more or different components and devices.

In embodiments of the present invention, a flat panel video display comprises a case structure, electronic connection means, and a removable input/output (I/O) cartridge. The I/O cartridge comprises the typical connectors for, for example, power cords and component connectors for external and peripheral devices, and a means for electronically connecting the connectors to the video display. The video display comprises a dock for accepting and docking the I/O cartridge and a means for cooperating with the I/O cartridge means for electronically connecting the connectors to the video display. The I/O (and optionally the A/C power) circuitry (circuit board) is enclosed in the I/O cartridge, which can be inserted into and removed from a similarly shaped cooperative cavity in the case of the video display. Both the cartridge and cavity have corresponding channels allowing the cartridge to slide properly into place while preventing incorrect insertion of the cartridge. Once the cartridge is fully inserted into the cavity, all electronic connections are made between the I/O circuit board (and optionally A/C power) in the cartridge and the rest of the video display are made allowing the display to function normally.

The cartridge body has a latching mechanism tensioned by a spring or equivalent means allowing the cartridge to lock into place in the video display. The latch can be disengaged by depressing a button on the exposed side of the cartridge, allowing the cartridge to be removed. The lip of the cartridge around the depressed button can serve as a handle to pull out the cartridge from the video display. If A/C power is integrated into the cartridge, the latch can activate a switch that breaks the connection of the hot wire and the neutral (leaving the ground connected) cutting power to all electronics in the cartridge and preventing a potentially harmful arc while removing or inserting the cartridge. Even with this extra protection, one should always unplug the device from the wall outlet before inserting/removing the cartridge.

These and other objects, features, and advantages of the present invention will become more apparent to those of ordinary skill in the art when the following detailed description of the preferred embodiments is read in conjunction with the appended figures.

### BRIEF DESCRIPTION OF THE DRAWINGS

FIG. 1 is a perspective view of an embodiment of the present invention attached to the rear of a video display.

FIG. 2 is a perspective view of the embodiment of the invention shown in FIG. 1 removed from the video display.

FIG. 3 is a more detailed perspective view of the embodiment of the invention shown in FIG. 1 highlighting the sliding means and the electronic connection means for connecting the invention to the video display.

FIG. 4 is a more detailed perspective view of the embodiment of the invention shown in FIG. 1 highlighting an alternative electronic connection means for connecting the invention to the video display.

FIG. 5 is a perspective view of an illustrative latching means for securing the invention onto the video display, with the latch in the released position.

FIG. 6 is a perspective view of the illustrative latching means shown in FIG. 5 for securing the invention onto the video display, with the latch in the secured position.

FIG. 7 is a perspective view of an illustrative configuration of the power connection of the invention in which the latch activates a switch that breaks the connection of the hot wire and the neutral (leaving the ground connected) showing the hot wire and neutral in the powered position.

FIG. 8 is a perspective view of the illustrative configuration of the power connection of the invention shown in FIG. 7 in which the latch activates a switch that breaks the connection of the hot wire and the neutral (leaving the ground connected) showing the hot wire and neutral in the unpowered position.

### DETAILED DESCRIPTION OF PREFERRED EMBODIMENTS

In one preferred embodiment, the present invention comprises a flat panel video display as generally described by existing art with the added modification of providing a separable, removable panel or cartridge for the circuitry of the input/output (I/O) electronics. The I/O (and optionally the A/C power) circuitry (circuit board) is enclosed in a cartridge, which can be inserted into and removed from a similarly shaped cavity in the case of the video display. Both the cartridge and cavity have corresponding channels, such as tongue and groove channels, allowing the cartridge to slide properly into place and remain in place while preventing incorrect insertion of the cartridge. Once the cartridge is fully inserted into the cavity, all electronic connections are made between the I/O circuit board (and optionally A/C power) in the cartridge and the rest of the display are made allowing the display to function normally. In use, the cartridge of the invention can be removed from the video display, the connectors (cables, cords, etcetera) connected to the cartridge, and then the cartridge can be reinserted into the video display. This greatly simplifies the connection of the connectors to the video display.

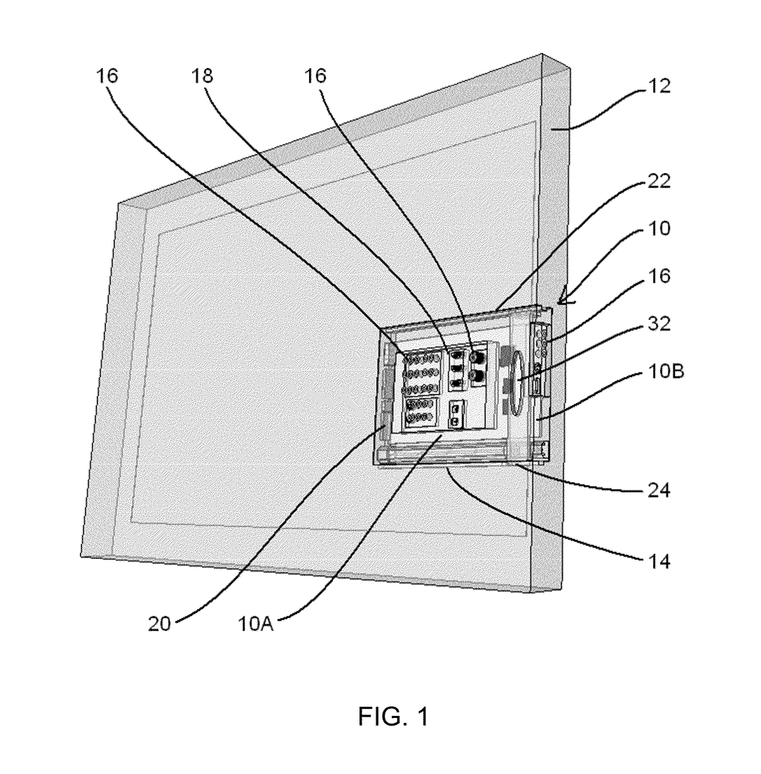

A first illustrative embodiment of the invention is shown in FIGS. 1-3. In a common video display 12, the I/O connectors share a circuit board with the video and audio processors and control circuitry for the video display 12, making it essentially the mainboard of the video display 12. In this first illustrative embodiment, the entire existing circuit board 18 is enclosed in the cartridge 10 and the multiple internal ribbon I/O cables run from their existing connectors 16 on the circuit board 18 to connection means 20 mounted on the side of the cartridge 10 that is seated into the video display 12. An opposite gendered connection means 30 is secured to the case of the video display 12 so that the cartridge 10 and the video display 12 are connected when the cartridge 10 is seated. Another set of I/O ribbons run from the connection means 30 on the video display 12 to the other components on the video display 12. It would be possible to modify an existing video display 12 unit to create this embodiment. By locating the circuit boards 18 on the cartridge 10, it is also possible to update the video display 12 by simply producing an updated cartridge 10 with a newer circuit board 18.

Referring now to FIG. 1, a perspective view of the first embodiment of the present invention, such as a cartridge 10, attached to the rear of a video display 12 is shown. The rear panel of the video display 12 comprises a slot 14 or compartment into which the cartridge 10 fits. The cartridge 10 comprises typical connectors 16, optionally both on the face 10A and the side wall 10B. The cartridge 10 further comprises a circuit board 18, such as a main board, for controlling the connectors 16. The cartridge 10 additionally comprises at least one connection means 20 for connecting the circuit board 18 and/or the connectors 16 to the video display 12. The top edge 22 and bottom edge 24 of the cartridge 10 comprises a groove or channel 26 (or alternatively a tongue) that cooperates with a tongue 28 (or alternatively a groove or channel) on the slot 14 for directing and holding the cartridge 10 within the slot 14.

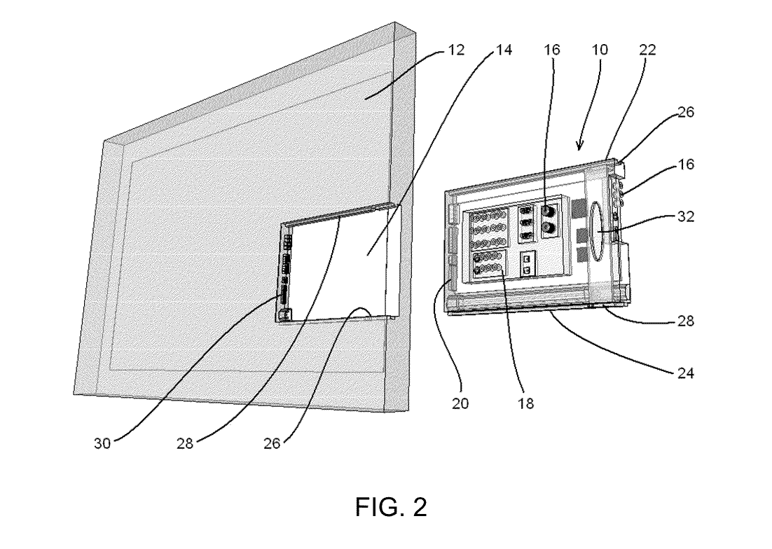

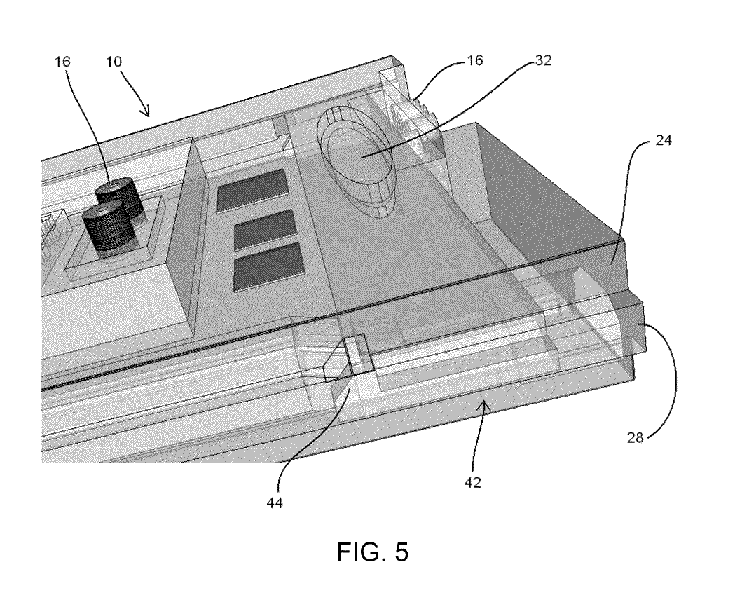

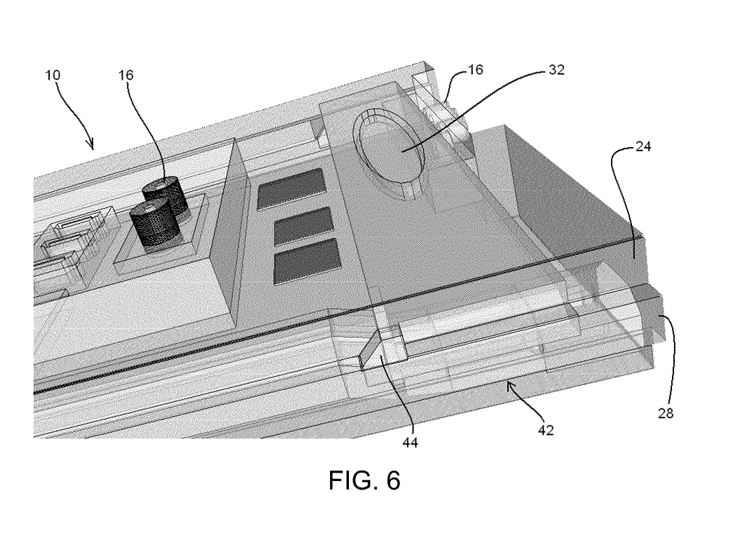

Referring now to FIG. 2 a perspective view of the embodiment of the cartridge 10 shown in FIG. 1 is shown removed from the video display 12. In this view, slot 14 can be seen in greater detail, as well as cooperating connection means 30, which cooperates with connection means 20 on the cartridge 10. Further, channel 26 and tongue 28 can be seen in more detail. Latch button 32 actuates locking latch 34 (see FIGS. 5 and 6 and the attendant disclosure below) for securing cartridge 10 within, and releasing cartridge 10 from, slot 14.

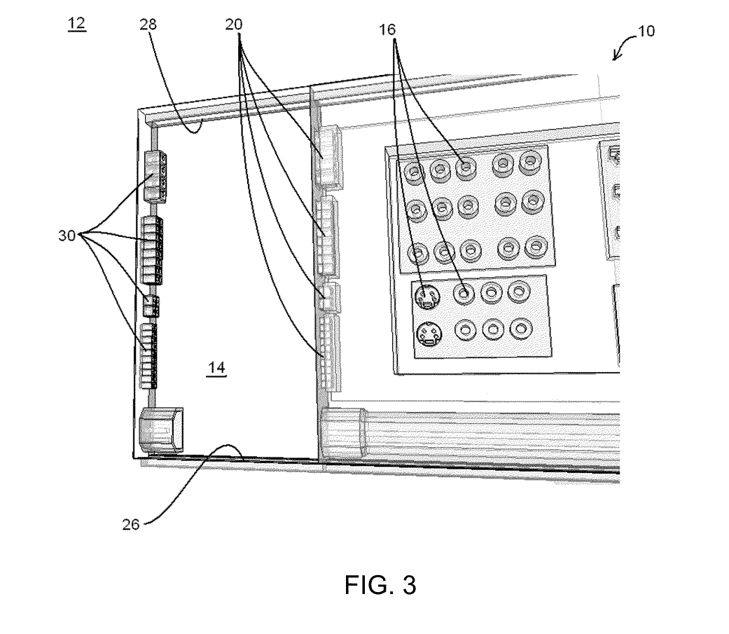

Referring now to FIG. 3, a more detailed perspective view of the embodiment of the cartridge 10 shown in FIG. 1 highlighting the sliding means, namely channel 26 and tongue 28, and the electronic connection means 20, 30 for connecting the cartridge 10 to the video display 12 is shown. A can be seen, cartridge 10 is shown within the slot 14 with connection means 20, 30 lined up with each other for connection. For example, as cartridge 10 is slided to the left (towards connection means 30), ultimately, connection means 20 will mate with connection means 30, thus providing for an electronic/electrical connection between cartridge 10 and video display 12. This view shows several different types of connection means 20, 30 pairings.

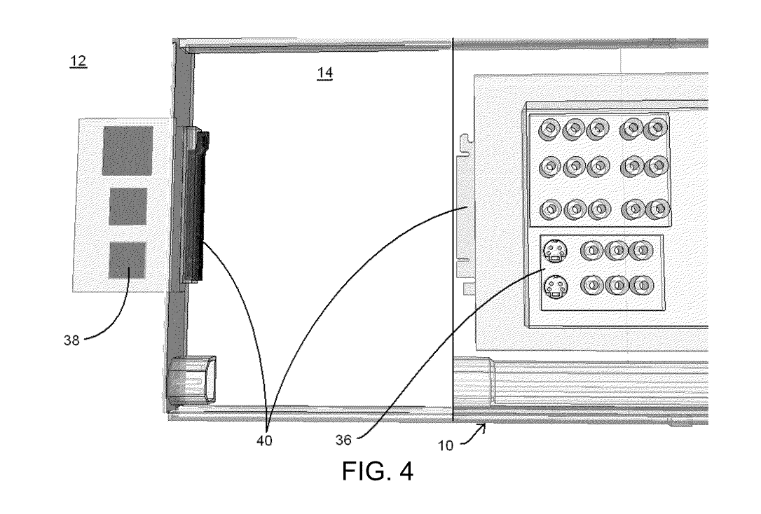

A second illustrative embodiment of the invention is shown in FIG. 4. The second embodiment splits the circuitry on the mainboard into two separate boards, a first circuit board 36 on the cartridge 10 containing the connectors 16 and their basic circuitry (typically the less expensive components) and a second circuit board 38 on the video display 12 containing the controllers and processors (typically the more expensive components). All connections between the two circuit boards 36, 38 would be made through a single bus 40, similar to a PCI Express port connecting a motherboard and a graphics card. The male end of the bus 40 would be on the cartridge 10 and the female end of the bus 40 on the video display 12 case. The advantage of this embodiment is that the modular piece (which is more likely to be lost or damaged while removed), namely the cartridge 10, is simpler and less costly, while the more complex components remain inside the video display 12 casing.

Referring now to FIG. 4, a more detailed perspective view of the second illustrative embodiment of the invention is shown highlighting an alternative electronic connection means 40 for connecting the cartridge 10 to the video display 12. The general features of this embodiment are the same as the first embodiment disclosed above, but with the circuit board 18 split into two circuit boards 36, 38, and the connection means 20, 30 being replaced with a bus 40.

A third illustrative embodiment, not shown, has the processors and circuit board 18; 36, 38 on the removable cartridge 10 as in the first embodiment and the single bus 40 connection of the second embodiment. This is an alternative manufactured embodiment, which would allow one to replace/upgrade the mainboard of the video display 12 if damaged, obsolete or simply if so desired by the user.

Referring now to FIG. 5, a perspective view of an illustrative latching mechanism 42 for securing the cartridge 10 onto the video display 12, with the latch 44 in the released position. The cartridge 10 body preferably has a latching mechanism 42 tensioned by a spring or spring equivalent allowing the latching mechanism 42 to lock into place. The latch 44 is disengaged by depressing a button 32 on the exposed side of the cartridge 10, allowing the cartridge 10 to be removed from the video display 12 and slot 14. The lip of the cartridge 10 around the button 32 can serve as a handle to pull out the cartridge 10. If A/C power is integrated into the cartridge 10, the latch 44 can be structured to activate a switch (not shown) that breaks the connection of the hot wire and the neutral (leaving the ground connected) cutting power to all electronics in the video display 12 and preventing a potentially harmful arc while removing or inserting the cartridge 10. Even with this extra protection, one should always unplug the device from the A/C wall outlet before inserting/removing the cartridge 10. Button 32 is shown in a downward position, as is latch 44.

Referring now to FIG. 6, a perspective view of the illustrative latching mechanism 42 is shown with the latch in the secured position. Button 32 is shown in an upward position, as is latch 44. Latch 44 cooperates with a catch (not shown) on the video display 12 casing.

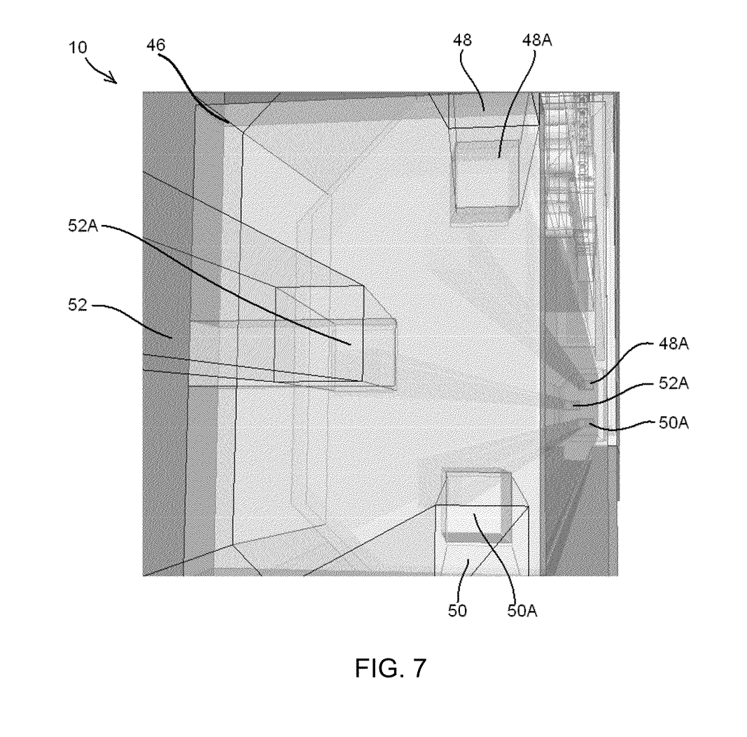

Referring now to FIG. 7, a perspective view of an illustrative configuration of the power connection 46 of the cartridge 10 in which the latch 44 also activates a switch that breaks the connection of the hot wire 48 and the neutral 50 (leaving the ground 52 connected) showing the hot wire 48 and neutral 50 in the powered position. Specifically, each of the hot wire 48, neutral 50 and ground 52 are shown cooperating with their respective sockets 48A, 50A, 52A.

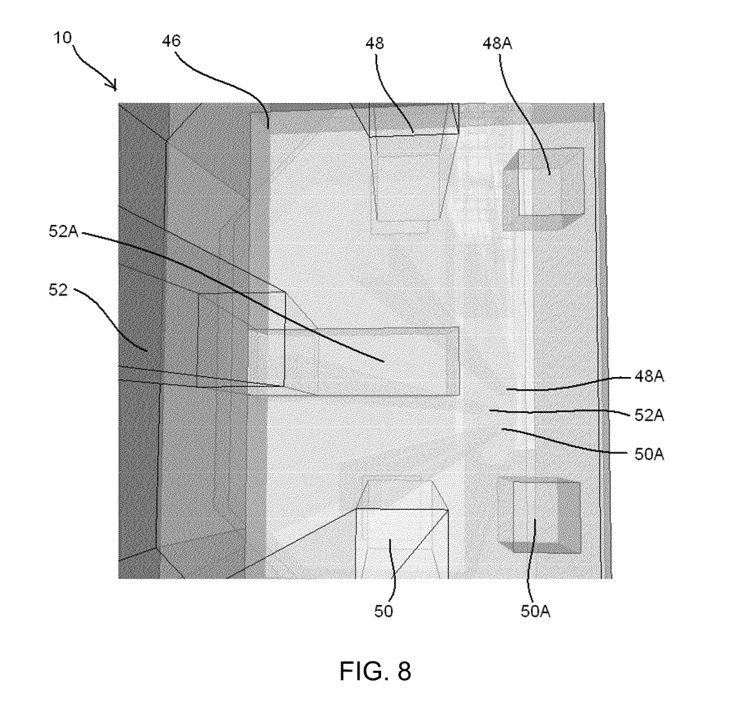

Referring now to FIG. 8, a perspective view of the illustrative configuration of the power connection 46 of the cartridge 10 shown in FIG. 7 in which the latch has activated the a switch to break the connection of the hot wire 48 and the neutral 50 (leaving the ground 52 connected) showing the hot wire 48 and neutral 50 in the unpowered position. As can be seen, each of the hot wire 48 and neutral 50 are shown in a depressed or lowered configuration when compared to FIG. 7, and thus not cooperating with their respective sockets 48A, 50A. Ground 52 also is depressed or lowered; however, ground socket 52A is elongated thus allowing ground 52 to remain in contact with ground socket 52, thus allowing cartridge 10 and video display 12 to remain grounded. This configuration allows the power to be stopped from the cartridge 10 and the video display 12 when inserting or removing the cartridge 10, while maintaining the ground, so as to prevent power surges or arcs.

In alternative embodiments, I/O connections can be oriented 90° on the cartridge 10 to allow the video display 12 to be mounted closer to the wall. For example, as can be seen on FIG. 1, some of the connectors 16 are located on the side wall 10B.

In another alternative embodiment, A/C power does not have to be integrated into the cartridge 10 mechanism.

In yet another alternative embodiment, the cartridge 10 can comprise an optional cover (not shown) to place over the connectors 16 to protect them and/or to better secure the cables and wires onto the connectors 16.

In still another alternative embodiment, fuses (not shown), such as low voltage fuses, can be incorporated in the wiring of the cartridge 10 to prevent overload damage to the electronics in the main housing of the video display 12. For example, if an electrical overload or surge strikes the cartridge 10, the fuse will prevent or lessen any transfer of the electrical overload or surge to the video display 12. Thus, the user may need to replace only the cartridge 10 and not the video display 12 after an electrical overload or surge. The fuse also can help protect the cartridge 10 itself. Also, a fault indicator light can be added to the cartridge 10 in case a fuse is blown. Additional safety devices and circuitry can be added to the cartridge 10 by those of ordinary skill in the art to protect the cartridge 10 and the video display 12.

Thus, in an exemplary embodiment, the invention is a video display with a removable input/output cartridge, comprising a video display case comprising a video display; a removable cartridge comprising electronic connectors; means for removably connecting the removable cartridge to the video display case; and electronic connection means for electronically connecting the electronic connectors of the removable cartridge to the video display.

In a preferred embodiment, the video display case further comprises the electronic circuitry for operating the video display and the removable cartridge further comprises the electronic circuitry for operating the electronic connectors. In another preferred embodiment, the removable cartridge further comprises the electronic circuitry for operating the video display and the electronic circuitry for operating the electronic connectors. In another preferred embodiment, the video display case further comprises the electronic circuitry for operating the video display and the electronic circuitry for operating the electronic connectors.

The video display with a removable input/output cartridge as claimed in claim 1, wherein the means for removably connecting the removable cartridge to the video display case comprises a dock on the video display case in to which the removable cartridge is releasably secured. In one embodiment, the dock is located on the rear of the video display case.

The electronic connection means can comprise cooperating connectors, a first connector on the removable cartridge and a second connector on the video display case, whereby when the removable cartridge is secured completely within the dock, the first connector cooperates with the second connector to allow electronic signals to pass between the removable cartridge and the video display case. Additionally, the electronic connectors can comprise connectors selected from the group consisting of video input and output connectors, cable television connectors, video game console connectors, and audio input and output connectors.

To provide an aesthetically pleasing device, in a preferred embodiment, the removable cartridge is removable from the video display case when the video display case is mounted on a wall.

In another preferred embodiment, electrical current for powering the video display can be routed through the removable cartridge and the removable cartridge can comprise means for breaking the electrical current connection to the video display case.

In another exemplary embodiment, the invention is a removable input/output cartridge for use in connection with a video display, the cartridge comprising electronic connectors; means for removably connecting the removable cartridge to the video display case; and means for electronically connecting the electronic connectors to the video display. In a preferred embodiment, the removable input/output cartridge comprises electronic circuitry for operating the electronic connectors. IN another preferred embodiment, the removable input/output cartridge comprises electronic circuitry for operating the video display.

The means for electronically connecting the electronic connectors to the video display can comprise a first connector for electronically cooperating with a second connector on the video display. Additionally, the electronic connectors can comprise connectors selected from the group consisting of video input and output connectors, cable television connectors, video game console connectors, and audio input and output connectors.

The means for removably connecting the removable cartridge to the video display case can comprise a tongue and groove system. The removable cartridge also can comprise a latch for securing the removable cartridge in a dock in the video display case.

Various other features can be included on the removable cartridge. For one example, one or more wireless components can be integrated onto the removable cartridge so as to make the device wireless ready. Such devices can include wireless networking components wherein the video display can be a part of a wireless network, wireless control components such as for remote controls, short distance wireless components such as Bluetooth® components for connecting smart phones and other smart devices such as tablet computers and pad computers to the video display, and other wireless devices such as microphones and headphones or speakers.

For another example, a voltage converter can be integrated onto the removable cartridge so as to make the device ready for use in different countries throughout the world. Different countries have different electrical systems and devices in different countries need to operate on different voltages. By incorporating one or more voltage converters on the removable cartridge, or by producing different removable cartridges with different voltage converters, a single video display can be used in countries with different voltage requirements by changing the removable cartridge.

For another example, one or more cable tuners can be integrated onto the removable cartridge so as to make the device ready for use in different countries throughout the world. Different countries have different cable systems such as PAL and NTSC. By incorporating one or more cable tuners on the removable cartridge, or by producing different removable cartridges with different region specific cable tuners, a single video display can be used in countries with different cable systems by changing the removable cartridge.

Thus, region specific removable cartridges can create benefits from having a uniform design and decreased manufacturing costs.

The above detailed description of the preferred embodiments, examples, and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. A video display with a removable input/output cartridge, comprising:
a) a video display case comprising a video display;
b) a removable cartridge comprising electronic connectors;
c) means for removably connecting the removable cartridge to the video display case; and
d) electronic connection means for electronically connecting the electronic connectors of the removable cartridge to the video display.

2. The video display with a removable input/output cartridge as claimed in claim 1, wherein the video display case further comprises the electronic circuitry for operating the video display and the removable cartridge further comprises the electronic circuitry for operating the electronic connectors.

3. The video display with a removable input/output cartridge as claimed in claim 1, wherein the removable cartridge further comprises the electronic circuitry for operating the video display and the electronic circuitry for operating the electronic connectors.

4. The video display with a removable input/output cartridge as claimed in claim 1, wherein the video display case further comprises the electronic circuitry for operating the video display and the electronic circuitry for operating the electronic connectors.

5. The video display with a removable input/output cartridge as claimed in claim 1, wherein the means for removably connecting the removable cartridge to the video display case comprises a dock on the video display case in to which the removable cartridge is releasably secured.

6. The video display with a removable input/output cartridge as claimed in claim 5, wherein the dock is located on the rear of the video display case.

7. The video display with a removable input/output cartridge as claimed in claim 5, wherein the electronic connection means comprises cooperating connectors, a first connector on the removable cartridge and a second connector on the video display case, whereby when the removable cartridge is secured completely within the dock, the first connector cooperates with the second connector to allow electronic signals to pass between the removable cartridge and the video display case.

8. The video display with a removable input/output cartridge as claimed in claim 1, wherein the electronic connectors comprise connectors selected from the group consisting of video input and output connectors, cable television connectors, video game console connectors, and audio input and output connectors.

9. The video display with a removable input/output cartridge as claimed in claim 1, wherein the removable cartridge is removable from the video display case when the video display case is mounted on a wall.

10. The video display with a removable input/output cartridge as claimed in claim 1, wherein electrical current for powering the video display is routed through the removable cartridge and the removable cartridge comprises means for breaking the electrical current connection to the video display case.

11. A removable input/output cartridge for use in connection with a video display, the cartridge comprising:
a) electronic connectors;
b) means for removably connecting the removable cartridge to the video display case; and
c) means for electronically connecting the electronic connectors to the video display.

12. The removable input/output cartridge as claimed in claim 11, further comprising electronic circuitry for operating the electronic connectors.

13. The removable input/output cartridge as claimed in claim 12, further comprising electronic circuitry for operating the video display.

14. The removable input/output cartridge as claimed in claim 11, wherein the means for electronically connecting the electronic connectors to the video display comprises a first connector for electronically cooperating with a second connector on the video display.

15. The removable input/output cartridge as claimed in claim 11, wherein the electronic connectors comprise connectors selected from the group consisting of video input and output connectors, cable television connectors, video game console connectors, and audio input and output connectors.

16. The removable input/output cartridge as claimed in claim 11, wherein the means for removably connecting the removable cartridge to the video display case comprises a tongue and groove system.

17. The removable input/output cartridge as claimed in claim 11, further comprising a latch for securing the removable cartridge in a dock in the video display case.
